(19) United States
(12) Patent Application Publication
(10) Pub. No.: US 2019/0199633 A1
(43) Pub. Date: Jun. 27, 2019

(54) METHOD AND APPARATUS FOR FORWARDING IN INFORMATION CENTRIC NETWORKING

(71) Applicant: Futurewei Technologies, Inc., Plano, TX (US)

(72) Inventors: Aytac Azgin, Santa Clara, CA (US); Ravishankar Ravindran, San Ramon, CA (US)

(73) Assignee: Futurewei Technologies, Inc., Plano, TX (US)

(21) Appl. No.: 15/855,863

(22) Filed: Dec. 27, 2017

(51) Int. Cl. H04L 12/745; H04L 29/06

(52) U.S. Cl. CPC H04L 45/748; H04L 69/22

(57) ABSTRACT

Aspects of the disclosure provide a network device that includes interface circuitry and processing circuitry. The processing circuitry is configured to receive a first interest packet carrying a first name, add an indicator for routing look-ahead in the first interest packet to generate a first updated interest packet, and select a first entry in a forwarding information base (FIB) based on a lookup in the FIB for matching entries to the first name. The first entry is indicative of an outgoing interface circuit. The processing circuitry is configured to forward the first updated interest packet via the outgoing interface circuit, and receive a data packet in response to the first updated interest packet. The data packet carries forwarding information of devices that forward the first updated interest packet. The processing circuitry is configured to store the forwarding information of the devices in the first entry.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Information centric networking (ICN) technology provides a network architecture that focuses on named information, and uses names in routing. For example, in a network that is implemented using ICN technology, a router includes a forwarding information base (FIB) that maintains a corresponding relationship of names to interfaces of the router. When an interest packet that carries a name for a content object of interest is received, an interface corresponding to the name is determined based on the FIB to forward the interest packet out of the router. The FIB can occupy a relatively large, such as over multi-GB, memory space, and is then generally stored in a low cost memory for cost reduction. Generally, low cost memory has a relatively high access latency. Thus, FIB operations, such as lookup operations, can take relatively long time.

### SUMMARY

Aspects of the disclosure provide a network device for information centric networking (ICN). The network device includes interface circuitry and processing circuitry. The interface circuitry is configured to receive signals carrying incoming packets and transmit signals carrying outgoing packets via interfaces. The processing circuitry is configured to receive a first interest packet carrying a first name for a content object to request, add an indicator for routing look-ahead in the first interest packet to generate a first updated interest packet, and select a first entry in a forwarding information base (FIB) based on a lookup in the FIB for matching entries to the first name. The first entry is indicative of an outgoing interface, forward the first updated interest packet via the outgoing interface that is indicated by the first entry. The processing circuitry is further configured to receive a data packet in response to the first updated interest packet. The data packet carries forwarding information of the first updated interest packet at devices that forward the first updated interest packet. The forwarding information of the first updated interest packet at the devices is then stored in the first entry.

Optionally, in any of the preceding aspects, another implementation of the aspect provides that the processing circuitry is configured to select the first entry with a longest prefix match (LPM) to the first name.

Optionally, in any of the preceding aspects, another implementation of the aspect provides that the processing circuitry is configured to selectively store a portion of the forwarding information with equal or shorter prefix matches than the LPM in the first entry.

Optionally, in any of the preceding aspects, another implementation of the aspect provides that the processing circuitry is configured to store the portion of the forwarding information with equal or shorter prefix matches in a second entry with a shorter prefix match than the LPM.

Optionally, in any of the preceding aspects, another implementation of the aspect provides that the processing circuitry is configured to set an indicator bit for identifying a portion of the forwarding information with a longer prefix match than the LPM.

Optionally, in any of the preceding aspects, another implementation of the aspect provides that the processing circuitry is configured to select, among the devices, consecutive devices to the network device that forward the first updated interest packet, and store forwarding information of the selected consecutive devices.

Optionally, in any of the preceding aspects, another implementation of the aspect provides that the processing circuitry is configured to store the forwarding information of the selected consecutive devices in a form of a list of identifiers for outgoing interfaces respectively at the selected consecutive devices.

Optionally, in any of the preceding aspects, another implementation of the aspect provides that the processing circuitry is configured to receive a second interest packet carrying a second name, select the first entry based on a lookup of matching entries in the FIB to the second name, add the forwarding information of the devices in the second interest packet to generate a second updated interest packet and forward the second updated interest packet via the outgoing interface that is indicated by the first entry.

Aspects of the disclosure provide a network device for information centric networking (ICN). The network device includes interface circuitry and processing circuitry. The interface circuitry is configured to receive signals carrying incoming packets and transmit signals carrying outgoing packets via interfaces. The processing circuitry is configured to receive, via a first interface, a first interest packet carrying a first name for a content object to request, detect an indicator for routing look-ahead in the first interest packet, and select a first entry in a forwarding information base (FIB) based on a lookup in the FIB for matching entries to the first name. The first entry is indicative of a second interface. The processing circuitry is further configured to forward the first updated interest packet via the second interface that is indicated by the first entry, receive a data packet in response to the first interest packet, add forwarding information of the first entry in the data packet to generate an updated data packet, and forward the updated data packet via the first interface.

Aspects of the disclosure provide a method for information centric networking (ICN). The method includes receiving, at a network device, a first interest packet carrying a first name for a content object to request, adding an indicator for routing look-ahead in the first interest packet to generate a first updated interest packet, and selecting a first entry in a forwarding information base (FIB) based on a lookup in the FIB for matching entries to the first name. The first entry is indicative of an outgoing interface of the network device. The method further includes forwarding the first updated interest packet via the outgoing interface that is indicated by the first entry, and receiving a data packet in response to the first updated interest packet. The data packet carries forwarding information of the first updated interest packet at devices that forward the first updated interest packet. Then, the method includes storing the forwarding information in the first entry.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a diagram of a network system 100 according to an embodiment of the disclosure;

FIG. 2 shows examples of interest packets and entries of pending interest tables according to an embodiment of the disclosure;

FIG. 3 shows examples of data packets and entries of forwarding information bases according to an embodiment of the disclosure;

FIG. 4 shows a block diagram of a network device according to an embodiment of the disclosure;

FIG. 5 shows a flow chart outlining a process example executed by a network device according to an embodiment of the disclosure;

FIG. 6 shows a flow chart outlining a process example executed by another network device according to an embodiment of the disclosure; and

FIG. 7 shows a flow chart outlining a process example executed by another network device according to an embodiment of the disclosure.

### DETAILED DESCRIPTION OF EMBODIMENTS

In the present disclosure, information centric networking (ICN) is used to refer to a networking architecture that focuses on named information. The networking architecture that focuses on named information can be referred to using other terms, such as content centric networking (CCN), named data networking (NDN), and the like.

Due to the usage of low cost memory for storing forwarding information base (FIB), techniques to counter the relatively high access latency of the low cost memory are needed in ICN to enable high speed forwarding. Aspects of the disclosure provide techniques for a network node in an information centric network to collect routing information of next hops on a forwarding path and to store the routing information of the next hops at the network node. The collecting of routing information of the next hops on the forwarding path is referred to as routing look-ahead, and the routing information of the next hops on the forwarding path is referred to as look-ahead forwarding information. Thus, a lookup operation at the network node extracts forwarding information of the network node and routing information of the next hops. The routing information of the next hops is provided to the next hops to allow the next hops to skip lookup operations.

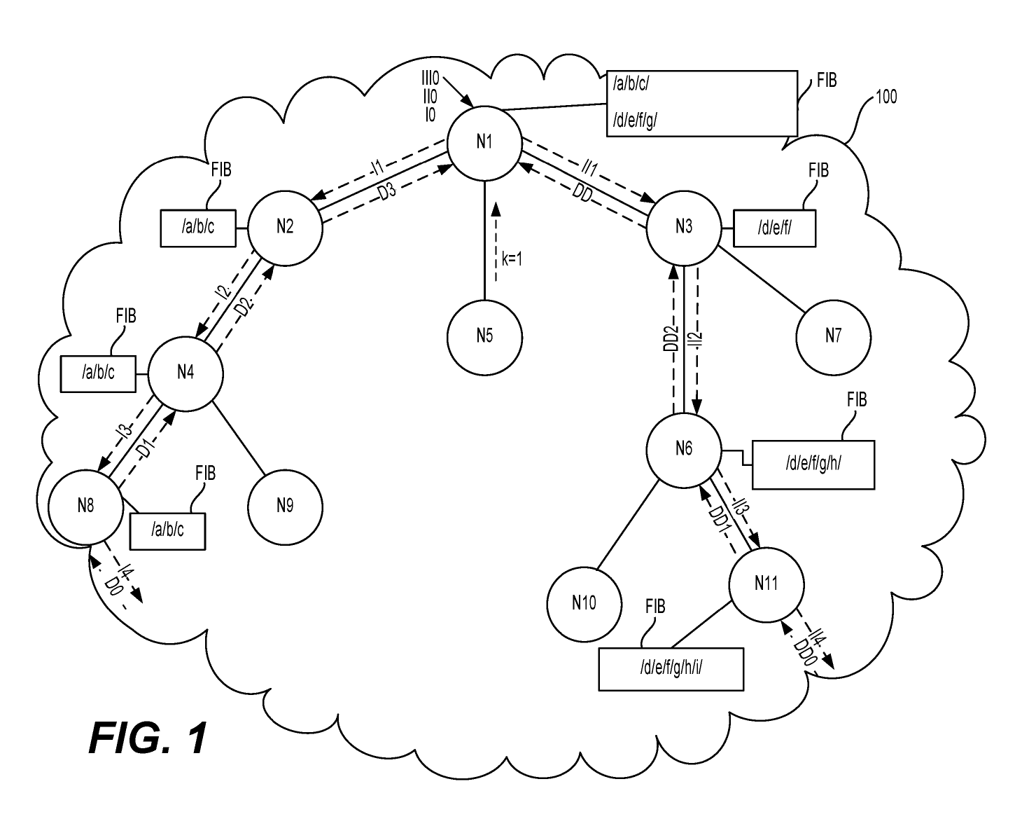

FIG. 1 shows a diagram of a network system 100 according to an embodiment of the disclosure. The network system 100 is configured to enable coordinated lookup that performs a lookup at a network node to extract forwarding information of multiple hops ahead of the network node, thus network nodes of the multiple hops can skip lookups of forwarding information.

The network system 100 includes a plurality of network nodes N1-N11 that implement information centric networking (ICN) technology. Packets in ICN are categorized into interest packets and data packets. An interest packet in ICN carries an interest (e.g., a request) for a content object. For example, an interest packet can carry a plurality of attributes of an interest, such as a content name for the content object, a remaining life time of the interest, a nonce value that is used with the content name to identify the interest packet, and the like. A data packet in ICN carries a data response to an interest (e.g., a request). For example, a data packet can carry a content name for a content object, the content object, and other attributes of the content object, such as a fresh period of the content object, and the like.

At least one of the network nodes, such as the network node N1, is configured to initiate a request of routing look-ahead with an interest packet. The network node N1 sends the request with the interest packet and receives a data packet with a response of routing look-ahead. The data packet carries routing information of the interest packet on a forwarding path of the interest packet. The routing information of the interest packet on the forwarding path is referred to as look-ahead forwarding information. The network node N1 is configured to extract the look-ahead forwarding information of network nodes that are ahead of the network node N1 on the forwarding path of the interest packet based on the response, and store the look-ahead forwarding information in an entry within a forwarding information base (FIB). In an example, the look-ahead forwarding information includes forwarding information of other network nodes on the forwarding path of the interest packet. Thus, when the network node N1 receives other interest packets that have matching names (or name prefixes) to the entry in the FIB, the network node N1 retrieves the look-ahead forwarding information from the entry. The look-ahead forwarding information is then used by the other network nodes to forward the other interest packets. Thus, the other network nodes can skip FIB lookups during processing of the other interest packets.

The network system 100 can be a single network or a plurality of networks of the same or different types. The network system 100 can include a fiber optic network in connection with a cellular network. The network system 100 can include one or more local area networks that are interconnected by wide-area networks and/or Internet. Further, the network system 100 can be a data network or a telecommunications or video distribution (e.g. cable, terrestrial broadcast, or satellite) network in connection with a data network. Any combination of telecommunications, video/audio distribution and data networks, whether a global, national, regional, wide-area, local area, or in-home network, can be used without departing from the spirit and scope of the disclosure.

In an embodiment, the network system 100 includes multiple network domains, such as a subscriber network domain, an Internet service provider network domain, and the like. The network nodes N1-N11 are within a network domain. Some network nodes, such as N11, are edge nodes (e.g., edge routers) that provide connectivity across domain borders.

The network nodes N1-N11 can be any suitable electronic devices, such as routers, network switches, laptops, tablets, smartphones, appliances, and the like that can join the network system 100 and exchange information with other devices.

In an embodiment, the network system 100 is an ad hoc network 100. For example, the network nodes N1-N11 are mobile devices that are configured to perform wireless communication. The ad hoc network 100 does not rely on a pre-existing infrastructure, such as routers in wired networks or access points in managed (infrastructure) wireless networks. In an example, each of the network nodes N1-N11 can participate the ad hoc network 100 dynamically to route for other nodes. The network nodes N1-N11 are free to move, and can respectively join or leave the ad hoc network 100 on the fly.

In another embodiment, the network system 100 is an Internet of things (IoT) network system 100. For example, the network nodes N1-N11 correspond to various physical objects, such as vehicles, home appliances, sensors, actuators, and the like with embedded networking interfaces, processing circuitry and software that enable the physical objects to connect and exchange information.

According to an aspect of the disclosure, the network system 100 is configured to handle communication functions according to layers in open systems interconnection model (OSI model). The OSI model includes, from bottom to top, physical layer (layer 1), data link layer (layer 2), network layer (layer 3), transport layer (layer 4), session layer (layer 5), presentation layer (layer 6) and application layer (layer 7), for example. According to an aspect of the disclosure, the ICN technology includes functions at the network layer to route information based on content name. In the present disclosure, information unit in the network layer is referred to as a packet. In an example, received electrical signals can be processed according to functions at the physical layer and data link layer to generate a packet that can be processed at the network layer. In another example, a packet for transmission is processed according to functions at the data link layer and the physical layer to generate electrical signals for transmission. For ease of description, the processing at the data link layer and the physical layer is omitted in the following description.

Packets can be categorized into interest packets and data packets according to the ICN technology. An interest packet includes a name of a content object of interest, and is generated by a consumer device according to the ICN technology in some embodiments. A data packet includes a content object and a name of the content object, and is generated by a producer device according to the ICN technology in some embodiments. In an example, a consumer device generates an interest packet with a name of a content object that the consumer device desires, and sends the interest packet to, for example, the network system 100. In an example, the network system 100 delivers the interest packet to a producer device that holds the content object. In the example, the producer device generates a data packet in response to the interest packet, and the data packet carries the name of the content object. In an example, the network system 100 then delivers the data packet to the consumer device via a reverse path of the interest packet.

Generally, a network node uses forwarding information base (FIB) to route interest packets to a next hop towards a producer device in the ICN technology. An FIB includes a plurality of entries that maintain corresponding relationships of name prefixes and outgoing interfaces for interest packets.

According to an aspect of the disclosure, the network nodes in the network system 100 may have asynchronous FIBs (e.g., different name prefixes in FIBs). In an embodiment, the network nodes are routers that have different number of interfaces, and the interfaces have different connectivity, and are connected to different devices. Thus, the routers can acquire content in different directions, and can have different levels of prefix aggregation in FIBs. Prefix aggregation refers to a combination of multiple FIB entries based on matching portion to form a new entry. In another embodiment, the network nodes join or leave the network system 100 dynamically in an ad hoc environment. The network nodes independently build respective FIBs that can be different from each other.

In some embodiments, FIBs are stored in low cost memories, such as memories with relative high latency. In an example, due to a large number of FIB entries, and/or variable-length names in the FIB entries, an FIB can occupy a relatively large, such as over multi-GB, memory space. In an embodiment, an FIB of a network node is then stored in a low cost memory, such as dynamic random access memory (DRAM) instead of static random access memory (SRAM), for cost reduction. The DRAM has a relatively high access latency compared to SRAM. Thus, FIB operations, such as lookup operations, at the network node can take longer time.

According to an aspect of the present disclosure, the coordinated lookup allows network nodes to exchange specific FIB entries on-demand and on-the-fly during packet forwarding to create traces of look-ahead forwarding information. When forwarding information of a path is required, network nodes on the path exchange the specific FIB entries associated with the path (referred to as on-demand), and the exchange happens during the packet forwarding on the path (referred to as on-the-fly). Thus, a lookup at a network node can extract look-ahead forwarding information of multiple network nodes, thus one or more lookups can be skipped to counter performance degradation impact of high latency memories.

Further, in some embodiments, one or more of the network nodes are implemented using low power devices, such as battery powered devices. FIB lookups can cause a relatively large number of signal switching and can be power consuming. Thus, when lookups are skipped, power consumption can be reduced.

Specifically, in the FIG. 1 example, the network nodes N1-N11 have respective FIBs. The FIBs can have synchronous entries (same name prefixes) or asynchronous entries (different name prefixes). For example, the FIBs of the network nodes N1, N2, N4 and N8 respectively have entries for name prefix “/a/b/c”. The entries are synchronous entries for the network nodes N1, N2, N4 and N8. In another example, the FIB of the network node N1 has an entry for name prefix “/d/e/f/g/”, the FIB of the network node N3 has an entry for name prefix “/d/e/f/”, the FIB of the network node N6 has an entry for name prefix “/d/e/f/g/h/”, the FIB of the network node N11 has an entry for name prefix “/d/e/f/g/h/i/”, and those entries are asynchronous entries.

The network nodes N1-N11 respectively include other data structures, such as pending interest table (PIT), and the like to assist routing named information. A PIT stores pending interests to which the corresponding data response have not been received yet.

During operation, in an example, the network node N1 receives an interest packet I0 with a name (or name prefix) “/a/b/c/”. The network node N1 looks up the FIB, and determines an entry with a longest prefix match (LPM) to the name “/a/b/c/”. In the example, the entry for “/a/b/c/” in the FIB of the network node N1 has LPM to the name “/a/b/c/” and is referred to as entry N1-FIB-LPM-1. The entry N1-FIB-LPM-1 is indicative of an outgoing interface that is connected to, for example, the network node N2. The network node N1 includes an indicator for routing look-ahead in the interest packet I0 to generate an interest packet I1, and sends the interest packet I1 via the outgoing interface that is connected to the network node N2. The network node N1 also updates (or adds) an entry in PIT, the entry has a matching name (same name prefix) to the name “/a/b/c/” in the interest packet I0, and the entry is referred to as entry N1-PIT-1. In an example, the network node N1 marks (e.g., sets a specific indicator) the entry N1-PIT-1 for indicating a start point of the request of routing look-ahead.

The network node N2 receives the interest packet I1 and detects the indicator for routing look-ahead. The network node N2 looks up the FIB, and determines an entry with an LPM to the name “/a/b/c/” in the interest packet I1. The entry for a name (or name prefix) “/a/b/c/” in the FIB of the network node N2 has LPM to the name “/a/b/c/” and is referred to as entry N2-FIB-LPM-1. The entry N2-FIB-LPM-1 is indicative of an outgoing interface that is connected to, for example, the network node N4. The network node N2 updates (or adds) an entry in a pending interest table (PIT) with matching name to the name “/a/b/c/” in the interest packet I1, and the entry is referred to as entry N2-PIT-1. The network node N2 marks the entry N2-PIT-1 for recipient of the request of routing look-ahead, and includes FIB matching entry information, such as a match length, an identifier of the outgoing interface of the entry N2-FIB-LPM-1, in the entry N2-PIT-1. The network node N2 forwards an interest packet I2 (e.g., same as the interest packet I1) via the outgoing interface that is connected to the network node N4.

The network node N4 receives the interest packet I2 and detects the indicator for routing look-ahead. The network node N4 looks up the FIB, and determines an entry with an LPM to the name “/a/b/c/” in the interest packet I2. The entry for “/a/b/c/” in the FIB of the network node N4 has LPM to the name “/a/b/c/” and is referred to as entry N4-FIB-LPM-1. The entry N4-FIB-LPM-1 is indicative of an outgoing interface that is connected to, for example, the network node N8. The network node N4 updates (or adds) an entry in a pending interest table (PIT) with matching name to the name “/a/b/c/” in the interest packet I2, and the entry is referred to as entry N4-PIT-1. The network node N4 marks the entry N4-PIT-1 for recipient of the request of routing look-ahead, and includes FIB matching entry information, such as a match length, an identifier of the outgoing interface of the entry N4-FIB-LPM-1, in the entry N4-PIT-1. The network node N4 forwards an interest packet I3 (e.g., same as the interest packets I1 and I2) via the outgoing interface that is connected to the network node N8.

The network node N8 receives the interest packet I3 and detects the indicator for routing look-ahead. The network node N8 looks up the FIB, and determines an entry with an LPM to the name “/a/b/c/” in the interest packet I3. The entry for “/a/b/c/” in the FIB of the network node N8 has LPM to the name “/a/b/c/” and is referred to as entry N8-FIB-LPM-1. The entry N8-FIB-LPM-1 is indicative of an outgoing interface of the network node N8. In an example, the network node N8 updates (or adds) an entry in a pending interest table (PIT) with the same name as the name “/a/b/c/” in the interest packet I3 and the entry is referred to as entry N8-PIT-1. The network node N8 marks the entry N8-PIT-1 for recipient of the request of routing look-ahead, and includes FIB matching entry information, such as a match length, an identifier of the outgoing interface of the entry N8-FIB-LPM-1, in the entry N8-PIT-1. In an example, the network node N8 is an edge router. When sharing in-domain information with outside routers is not allowed (e.g., by a policy, a rule), the network node N8 terminates the request for routing look-ahead. For example, the network node N8 removes the indicator for routing look-ahead from the interest packet I3 to generate an interest packet I4, and forwards the interest packet I4 via the outgoing interface. It is noted that when sharing in-domain information is allowed, the network node N8 can keep the request for routing look-ahead and forward the interest packet I3.

The network node N8 receives a data packet D0 in response to the interest packet I4. The data packet includes the same name as the name “/a/b/c/” in the interest packet I0, the interest packets I1, I2, I3 and I4. The network node N8 looks up the PIT to find the entry N8-PIT-1 with the matching name to the name “/a/b/c/” in the data packet. The entry N8-PIT-1 is indicative of an incoming interface for the interest packet I3 that is connected to, for example, the network node N4. The entry N8-PIT-1 is marked previously for the recipient of the request of routing look-ahead, and includes the FIB matching entry information, such as the match length, the identifier of the outgoing interface for the interest packet I4 of the entry N8-FIB-LPM-1. The network node N8 adds the FIB matching entry information in (e.g., packet header of) the data packet D0 to generate a data packet D1. The network node N8 forwards the data packet D1 to the network node N4 via the incoming interface for the interest packet I3.

The network node N4 receives the data packet D1 in response to the interest packet I3. The network node N4 looks up the PIT to find the entry N4-PIT-1 with the matching name to the name “/a/b/c/” in the data packet D1. The entry N4-PIT-1 in the PIT is indicative of an incoming interface for the interest packet I2 that is connected to, for example, the network node N2. The entry N4-PIT-1 is marked previously for the recipient of the request of routing look-ahead, and includes the FIB matching entry information, such as the match length, the identifier of the outgoing interface for the interest packet I3 according to the entry N4-FIB-LPM-1. The network node N4 adds the FIB matching entry information in the data packet D1 to generate a data packet D2. Then, the network node N4 sends the data packet D2 to the network node N2 via the incoming interface for the interest packet I2.

The network node N2 receives the data packet D2 in response to the interest packet I2. The network node N2 looks up the PIT to find the entry N2-PIT-1 with the matching name to the name “/a/b/c/” in the data packet D2. The entry N2-PIT-1 is indicative of an incoming interface for the interest packet I1 that is connected to, for example, the network node N1. The entry N2-PIT-1 is marked previously for the recipient of the request of routing look-ahead, and includes the FIB matching entry information, such as the match length, the identifier of the outgoing interface for the interest packet I2 according to the entry N2-FIB-LPM-1. The network node N2 adds the FIB matching entry information in the data packet D2 to generate a data packet D3. Then, the network node N2 sends the data packet D3 to the network node N1 via the incoming interface for the interest packet I1.

The network node N1 receives the data packet D3 in response to the interest packet I1. The network nodes N1 looks up the PIT to find the entry N1-PIT-1 with the matching name to the name “/a/b/c/” in the data packet D3. The entry N1-PIT-1 is indicative of an incoming interface for the interest packet I0. The entry N1-PIT-1 is marked previously for the start point of the request of routing look-ahead. Then, the network node N1 extracts, from the data packet D3, the FIB matching entry information of the network node N2, the FIB matching entry information of the network node N4, and the FIB matching entry information of the network node N8, and adds in the FIB, for example in the entry N1-FIB-LPM-1. In an example, the network node N1 adds the FIB matching entry information of all the hops, such as the network node N2 and the network node N4, in the entry N1-FIB-LPM-1. For example, the network node N1 adds a list of identifiers for outgoing interface circuits respective at the network node N2 and the network node N4 in the entry N1-FIB-LPM-1.

In another example, the network node N1 adds FIB matching entry information of a subset of consecutive k hops to the network node N1 in the entry N1-FIB-LPM-1, where k is a positive integer. For example, when k equals one, the network node N1 adds the FIB matching entry information of the network node N2 in the entry N1-FIB-LPM-1. In an example, the number of k is adjustable locally by the network node N1. In another example, the number of k can be adjusted in response to a request from a central controller, for example the network node N5, that is external to the network node N1.

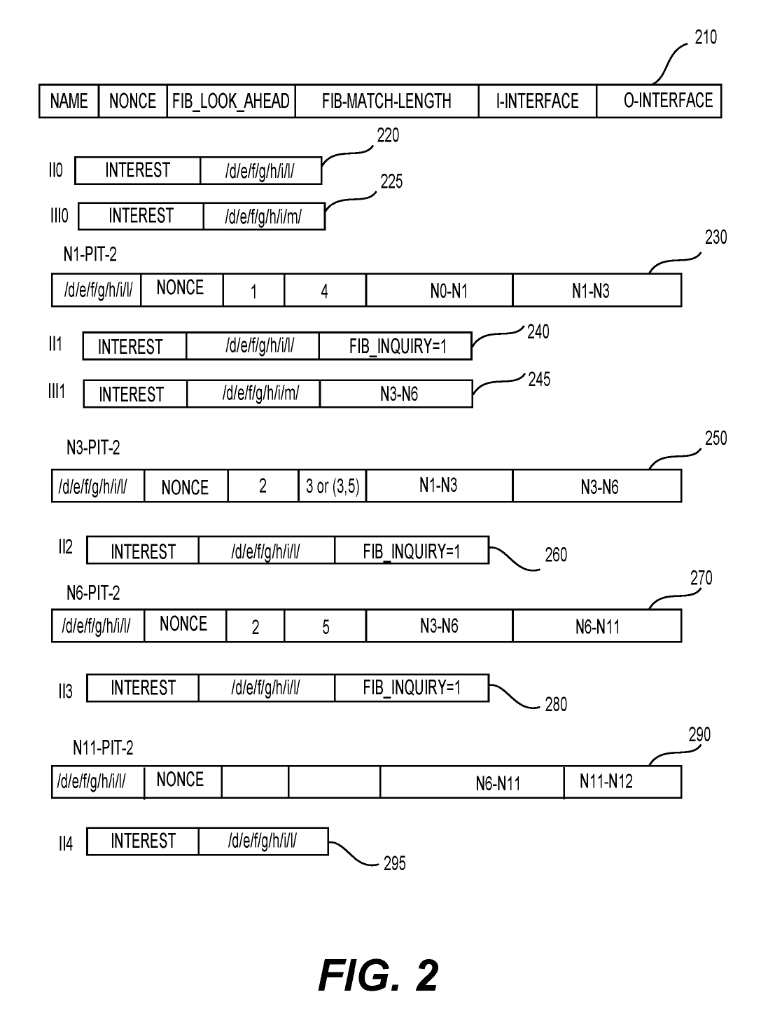

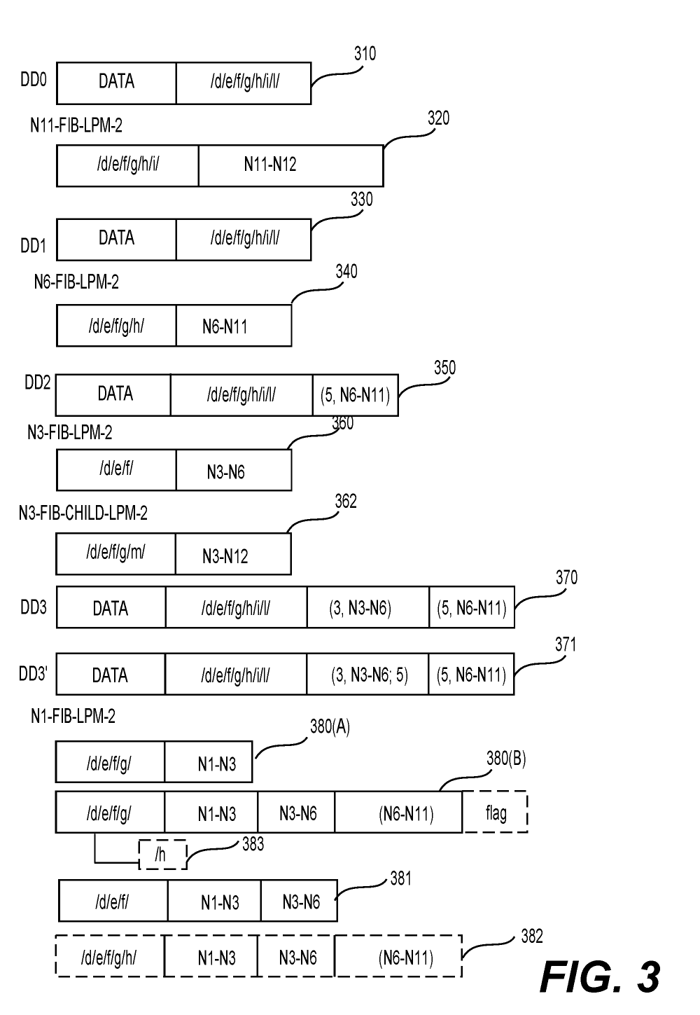

The techniques of routing look ahead will be further discussed with reference to FIG. 1, FIG. 2 and FIG. 3. FIG. 2 and FIG. 3 show examples of interest packets, entries of PITs, data packets and entries of FIBs in an example that the network device N1 receives an interest packet II0 with a name “/d/e/f/g/h/i/l/”.

An entry in a PIT includes a plurality of fields, such as a name field, a nonce field, a FIB look-ahead indicator field, a FIB match length field, an incoming interface (I-INTERFACE) field and an outgoing interface (0-INTERFACE) field as shown by 210 in FIG. 2. For an entry corresponding to an interest packet, the name field specifies a name in the interest packet for a desired content object; the nonce field specifies an identifier of the interest packet; the FIB look-ahead indicator field specifies an indicator for FIB look-ahead attribute, such as “1” for a start point of a request of routing look-ahead, “2” for a recipient of a request of routing look-ahead, and the like; the FIB match length field specifies the longest prefix match length in FIB to the name in the interest packet; the incoming interface field identifies one or more incoming interfaces of interest packets having the name; the outgoing interface field identifies one or more outgoing interfaces for the interest packets.

The interest packet II0 is shown as 220 in FIG. 2. The network node N1 receives the interest packet II0 via an incoming interface, such as an incoming interface that is referred to as NO-N1 of the network node N1. The network node N1 looks up the FIB, and identifies an entry with a longest prefix match (LPM) to the name“/d/e/f/g/h/i/l/”. The entry for “/d/e/f/g/” in the FIB of the network node N1 has LPM to the name “/d/e/f/g/h/i/l/” and is referred to as entry N1-FIB-LPM-2 as shown by 380(A) in FIG. 3. The entry N1-FIB-LPM-2 is indicative of an outgoing interface N1-N3 that is connected to the network node N3. The network node N1 generates an interest packet II1 as shown by 240 in FIG. 2. The interest packet II1 is generated based on the interest packet II0 and includes an indicator for routing look-ahead. The network node N1 sends the interest packet II1 via the outgoing interface that is connected to the network node N3. The network node N1 also updates (or adds) an entry in a pending interest table (PIT) with the same name as the name in the interest packet II0, and the entry is referred to as entry N1-PIT-2 as shown by 230. In an example, the network node N1 marks the entry N1-PIT-2 for indicating a start point of the request of routing look-ahead (e.g., sets the FIB look-ahead indicator field to “1”).

The network node N3 receives the interest packet II1 via an incoming interface N1-N3 of the network node N3 and detects the indicator for routing look-ahead in the interest packet M. The network node N3 looks up the FIB, and determines an entry with a LPM to the name “/d/e/f/g/h/i/l/” in the interest packet M. The entry for “/d/e/f/” in the FIB of the network node N3 has LPM to the name “/d/e/f/g/h/i/l/” and is referred to as entry N3-FIB-LPM-2 as shown by 360 in FIG. 3. The entry N3-FIB-LPM-2 is indicative of an outgoing interface N3-N6 that is connected to the network node N6. The network node N3 updates (or adds) an entry in a pending interest table (PIT) with the same name as the name “/d/e/f/g/h/i/l/” in the interest packet II1, and the entry is referred to as entry N3-PIT-2 as shown by 250 in FIG. 2. The network node N3 marks the entry N3-PIT-2 for recipient of the request of routing look-ahead (e.g., sets the FIB look-ahead indicator field to “2”), and includes FIB matching entry information of the entry N3-FIB-LPM-2, such as a match length, an identifier of the outgoing interface, and the like in the entry N3-PIT-2. The network node N3 forwards an interest packet I12, as shown by 260 in FIG. 2, (e.g., same as the interest packet II1) via the outgoing interface that is connected to the network node N6.

The network node N6 receives the interest packet I12 via an incoming interface N3-N6 of the network node N6 and detects the indicator for routing look-ahead from the interest packet I12. The network node N6 looks up the FIB, and determines an entry with a LPM to the name “/d/e/f/g/h/i/l/” in the interest packet I12. The entry for “/d/e/f/g/h/” in the FIB of the network node N6 has LPM to the name “/d/e/f/g/h/i/l/” and is referred to as entry N6-FIB-LPM-2 as shown by 340 in FIG. 3. The entry N6-FIB-LPM-2 is indicative of an outgoing interface N6-N11 that is connected to, for example, the network node N11. The network node N6 updates (or adds) an entry in a pending interest table (PIT) with the same name as the name “/d/e/f/g/h/i/l/” in the interest packet I12, and the entry is referred to as entry N6-PIT-2 as shown by 270 in FIG. 2. The network node N6 marks the entry N6-PIT-2 for recipient of the request of routing look-ahead, and includes FIB matching entry information of the entry N6-FIB-LPM-2, such as a match length, an identifier of the outgoing interface, and the like in the entry N6-PIT-2. The network node N6 forwards an interest packet I13, as shown by 280 in FIG. 2, (e.g., same as the interest packets II1 and II2) via the outgoing interface that is connected to the network node N11.

The network node N11 receives the interest packet I13 via an incoming interface N6-N11 and detects the indicator for routing look-ahead in the interest packet I13. The network node N11 looks up the FIB, and determines an entry with a LPM to the name “/d/e/f/g/h/i/l/” in the interest packet I13. The entry for “/d/e/f/g/h/i/” in the FIB of the network node N11 has LPM to the name “/d/e/f/g/h/i/l/” and is referred to as entry N11-FIB-LPM-2 as shown by 320 in FIG. 3. The entry N11-FIB-LPM-2 is indicative of an outgoing interface N11-N12 of the network node N11. The network node N11 updates/adds an entry in a pending interest table (PIT) with matching name to the “/d/e/f/g/h/i/l/” name in the interest packet I13, and the entry is referred to as entry N11-PIT-2 as shown by 290 in FIG. 2.

In an embodiment, the network node N11 is an edge router of a domain, such as a subscriber network domain, an Internet service provider network domain and the like, that forwards interest packets across domain border. When sharing in-domain information with outside routers is not allowed, the network node N11 terminates the request for routing look-ahead. When sharing in-domain information with outside routers is allowed, the network node N11 forwards the request for routing look-ahead across domain border. The network node N11 may mark the entry N11-PIT-2 for the request of routing look-ahead, or not (e.g., leave the FIB look-ahead indicator field and the FIB match length field empty) depending on its local or domain-specific policies. To terminate the request for routing look-ahead, the network node N11 removes the indicator for routing look-ahead from the interest packet I13 to generate an interest packet I14 as shown by 295 in FIG. 2, and forwards the interest packet I14 via the outgoing interface.

The network node N11 receives a data packet DD0, as shown by 310 in FIG. 3, in response to the interest packet I14. The data packet DD0 includes the same name as the name in the interest packet II0, the interest packets II1, II2, II3 and II4. The network node N11 looks up the PIT to find the entry N11-PIT-2 with the matching name to the name “/d/e/f/g/h/i/l/” in the data packet DD0. The entry N11-PIT-2 is indicative of the incoming interface N6-N11 of the interest packet I13 that is connected to, for example, the network node N6. When the network node N11 does not mark the PIT entry to supporting look ahead by including FIB match length, the network node N11 forwards a data packet DD1 as shown by 330 in FIG. 3, (e.g., same as the received data packet DD0) to the network node N6 via the interface N6-N11.

The network node N6 receives the data packet DD1 in response to the interest packet I13. The network node N6 looks up the PIT to find the entry N6-PIT-2 with the matching name to the name “/d/e/f/g/h/i/l/” in the data packet DD1. The entry N6-PIT-2 in the PIT is indicative of an incoming interface N3-N6 for the interest packet I12 that is connected to, for example, the network node N3. The entry N6-PIT-2 is previously marked for the recipient of the request of routing look-ahead, and includes the FIB matching entry information of the entry N6-FIB-LPM-2, such as the match length, the identifier of the outgoing interface for the interest packet I3, and the like at the network node N6. The network node N6 adds the FIB matching entry information in the data packet DD1 to generate a data packet DD2 as shown by 350 in FIG. 3. Then, the network node N6 sends the data packet DD2 to the network node N3 via the interface N3-N6.

The network node N3 receives the data packet DD2 in response to the interest packet I12. The network node N3 looks up the PIT to find the entry N3-PIT-2 with the matching name to the name “/d/e/f/g/h/i/l/” in the data packet DD2. The entry N3-PIT-2 is indicative of an incoming interface N1-N3 for the interest packet II1 that is connected to, for example, the network node N1. The entry N3-PIT-2 is marked previously for the recipient of the request of routing look-ahead, and includes the FIB matching entry information of the entry N3-FIB-LPM-2, such as the match length, the identifier of the outgoing interface for the interest packet I12, and the like at the network node N3. The network node N3 adds the FIB matching entry information in the data packet DD2 to generate a data packet DD3 as shown by 370 in FIG. 3. Then, the network node N3 sends the data packet DD3 to the network node N1 via the interface N1-N3.

The network node N1 receives the data packet DD3 in response to the interest packet M. The network node N1 looks up the PIT to find the entry N1-PIT-2 with the matching name to the name “/d/e/f/g/h/i/l/” in the data packet DD3. The entry N1-PIT-2 is indicative of an incoming interface NO-N1 for the interest packet II0. The entry N1-PIT-2 is marked previously for the start point of the request of routing look-ahead. Then, the network node N1 extracts, from the data packet DD3, the FIB matching entry information of the network node N3 and the FIB matching entry information of the network node N6, and adds the extracted FIB matching entry information in the FIB, for example in the entry N1-FIB-LPM-2 as shown by 380(B).

In an example, the network node N1 selectively adds the FIB matching entry information in the entry N1-FIB-LPM-2 based on match length. For example, the match length of the network node N3 is shorter than the match length of the network node N1, thus the network node N1 adds the FIB matching entry information of the network node N3 in the entry N1-FIB-LPM-2. The match length of the network node N6 is longer than the match length of the network node N1, thus the network node N1 does not add the FIB matching entry information of the network node N6 in the entry N1-FIB-LPM-2.

In another example, the network node N1 adds another entry in the FIB with a shorter prefix match than N1-FIB-LPM-2. For example, the network node N1 adds a new entry for “/d/e/f/” in the FIB as shown by 381 in FIG. 3. Further, in an example, the network node N1 adds an indicator for the outgoing interface that is connected to the network node N3 in the new entry, and adds, in the new entry, the FIB matching entry information of the network node N3, such as an indicator for the outgoing interface of the network node N3 that is connected to the network node N6.

In another example, the network node N1 adds the FIB matching entry information of the network node N6, such as an indicator for the outgoing interface of the network node N6 that is connected to the network node N11, in the entry N1-FIB-LPM-2, but marks (sets an indicator bit for example to “1”) the FIB matching entry information of the network node N6 to identify the longer prefix match than N1-FIB-LPM-2.

The network node N1 further receives an interest packet III0 with a name “/d/e/f/g/h/i/m/” as shown by 225 in FIG. 2. The network node N1 looks up the FIB, and determines an entry with a longest prefix match (LPM) to the name “/d/e/f/g/h/i/m/”. In an example, when the entry N1-FIB-LPM-2 has LPM to the name “/d/e/f/g/h/i/m/”, the network node N1 extracts, from the entry N1-FIB-LPM-2, a first indicator that is indicative of the outgoing interface of the network node N1 (e.g., connected to the network node N3), and a second indicator that is indicative of the outgoing interface of the network node N3 (e.g., connected to the network node N6). In an example, the network node N1 generates an updated interest packet III1 based on the interest packet III0 and adds the second indicator in the updated interest packet III1 as shown by 245 in FIG. 2. The network node N1 forwards the updated interest packet III1 via the outgoing interface that is indicated by the first indicator. When the network node N3 receives the updated interest packet III1, the network node N3 extracts the second indicator from the updated interest packet III1 and determines the outgoing interface that is indicated by the second indicator for further interest packet forwarding. Thus, the network node N3 can skip FIB lookup on the name “/d/e/f/g/h/i/m/”.

Further, according to an aspect of the disclosure, in addition to the FIB matching entry information, FIB child-matching entry information can be feedbacked to the first device that initiates the routing look-ahead. The FIB child-matching entry information refers to matching information of child entries to the LPM entry. In an example, a child entry to a specific entry has longer prefix compared to the specific entry, and the specific entry can be referred to as a parent entry. A parent entry can have multiple child entries. For example, an entry for “/d/e/f/g/” is a child entry for a parent entry “/d/e/f/”; an entry for “/d/e/f/g/m/” is also a child entry for the parent entry “/d/e/f/”. In an example, the LPM entry can have a child entry that is partially matching to the received content name in the interest packet due to for example a nearby cache for the content of the content name. The partially matching length of the name prefix of the child entry is referred to as a component matching length, and the length to the first unmatched portion is referred to as a miss length. In an example, the entry N3-FIB-LPM-2 has a child entry of “/d/e/f/g/m/” that is referred to as N3-FIB-CHILD-LPM-2 in FIG. 3. The entry N3-FIB-CHILD-LPM-2 is indicative of an outgoing interface, for example referred to as N3-N12. In the example that the content name is “/d/e/f/g/h/i/l/”, and the component matching length of the entry N3-FIB-CHILD-LPM-2 is 4, and the miss length is 5.

The LPM entry can have multiple child entries, and the highest miss length of the child entries is feedbacked to the start device that initiates the routing look-ahead as the FIB child-matching entry information. The highest miss length can alert the start device regarding the miss. For the network node N3, when the content name is “/d/e/f/g/h/i/l/”, the length of the LPM is 3 based on the entry N3-FIB-LPM-2, and the highest miss length is 5 based on the entry N3-FIB-CHILD-LPM-2. Then, a metric that includes the length of the LPM and the highest miss length, such as (3,5) is stored in the entry N3-PIT-2. In an example, the network node N3 receives the data packet DD2, the network node N3 adds the FIB matching entry information and the highest miss length in the data packet DD2 to generate a data packet DD3′ as shown by 371 in FIG. 3. Then, the network node N3 sends the data packet DD3′ to the network node N1 via the interface N1-N3.

The network node N1 receives the data packet DD3′ in response to the interest packet M. The network node N1 detects the highest miss length (e.g., 5) from data packet DD3′, and creates a virtual entry which is a temporary FIB entry created to address the presence of child entries with higher component matching lengths than the LPM entry. The virtual entry is for name prefix that matches the content name according to the highest miss length. For example, when the content name is “/d/e/f/g/h/i/l/”, the highest miss length is 5, then the virtual entry is for “/d/e/f/g/h/”. In an embodiment, the virtual entry is a separate FIB entry, such as shown by 382 in FIG. 3, that includes the outgoing interface and FIB matching entry information of N3 and N6 for example. In another embodiment, the virtual entry is implemented by for instance with a subentry as shown by 382 of additional prefix component “/h” in the entry 380(B). In another embodiment, the virtual entry is implemented using a single bit flag in the entry 380(B).

In an example, when the network node N1 receives an interest packet with a name “/d/e/f/g/h/”, the network node N1 looks up the FIB, and determines that the virtual entry has the LPM to the name “/d/e/f/g/h/i/m/”, and can use the information in the virtual entry for routing look-ahead.

In another example, when the network node N1 receives an interest packet with a name “/d/e/f/g/m/”, the network node N1 looks up the FIB, and determines a miss to the virtual entry. In an example, the network node N1 can trigger a new routing look-ahead process to discover the entry N3-FIB-CHILD-LPM-2 as the LPM at the network node N3 for the name “/d/e/f/g/m/”, which can be the optimal forwarding path to the nearby cache for the content of the name “/d/e/f/g/m/”. Similarly, the new routing look-ahead information can be feedbacked to the network node N1 for future routing.

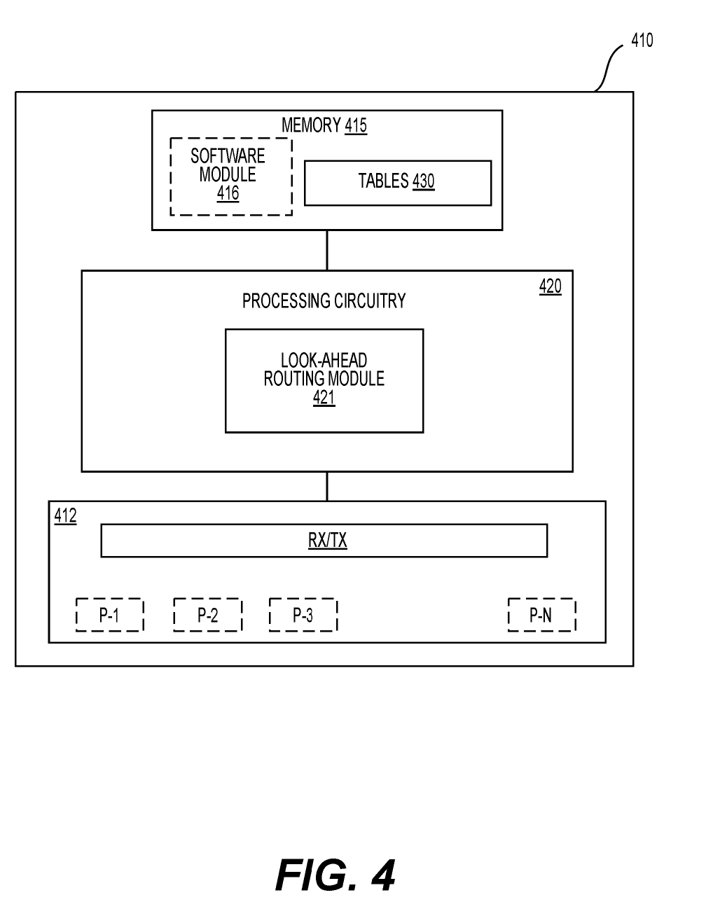

FIG. 4 shows a block diagram of a network device 410 according to an embodiment of the disclosure. In an example, the plurality of network nodes N1-N11 is respectively configured similarly as the network device 410. The network device 410 includes various functional circuit blocks, such as interface circuitry 412, processing circuitry 420, memory 415, and the like coupled together for example using suitable interconnection architecture (not shown), such as a bus architecture.

The interface circuitry 412 includes suitable circuits such as transmitting circuitry TX, receiving circuitry RX, and the like to form a plurality of network interfaces P-1 to P-N. In an example, each of the plurality of network interfaces P-1 to P-N is configured to couple another suitable device in a communication network via a respective communication link. The network interfaces P-1 to P-N can be physical interfaces or air (radio based) interfaces. In an example, the network interfaces P-1 to P-N are physical interfaces that are configured according to Ethernet technology, and Ethernet cables are used to couple other devices to the network device 410 via the network interfaces P-1 to P-N. The network interfaces P-1 to P-N respectively include receiving circuits (that are parts of receiving circuitry RX) for receiving signals from the Ethernet cables and transmitting circuits (that are parts of transmitting circuitry TX) for transmitting signals onto the Ethernet cables.

In another example, the network interfaces P-1 to P-N are air interfaces for wireless communication, such as cellular communication, WiFi communication, and the like between the network device 410 and other devices. The network interfaces P-1 to P-N respectively include allocated radio resources, such as time, frequency, coding scheme, and the like to form communication channels for the wireless communication between the network device 410 and the other devices. The transmitting circuitry TX can transmit wireless signals that multiplex the communication channels. The receiving circuitry RX can receive wireless signals, and de-multiplex the received signals to extract information in respective communication channels.

It is noted that, in another example, some of the network interfaces P-1 to P-N are physical interfaces and others are air interfaces.

The processing circuitry 420 is configured to process packets and to determine actions, such as sending a packet to a destination, encryption/decryption, fragmentation, multicasting, dropping a packet, and the like. In an embodiment, the processing circuitry 420 is implemented using dedicated packet processing circuits. In another embodiment, the processing circuitry 420 is implemented using one or more general processing circuit units, such as multi-processing cores, processors, and the like that can execute software instructions for packet processing.

In an embodiment, the memory 415 stores software modules 416 for packet processing. In an example, the processing circuitry 420 is implemented using a processor, and the processor executes the software modules 416 to perform packet processing. The memory 415 is implemented using any suitable storage device, such as a static random access memory (SRAM), a dynamic random access memory (DRAM), a flash memory, a solid state drive, a hard drive, an optical drive, and the like.

In an embodiment, an ICN approach uses a plurality of tables 430 to track information for routing, and the plurality of tables 430 is stored in the memory 415. In an example, the plurality of tables 430 includes a pending interest table (PIT), a forwarding information base (FIB) and the like.

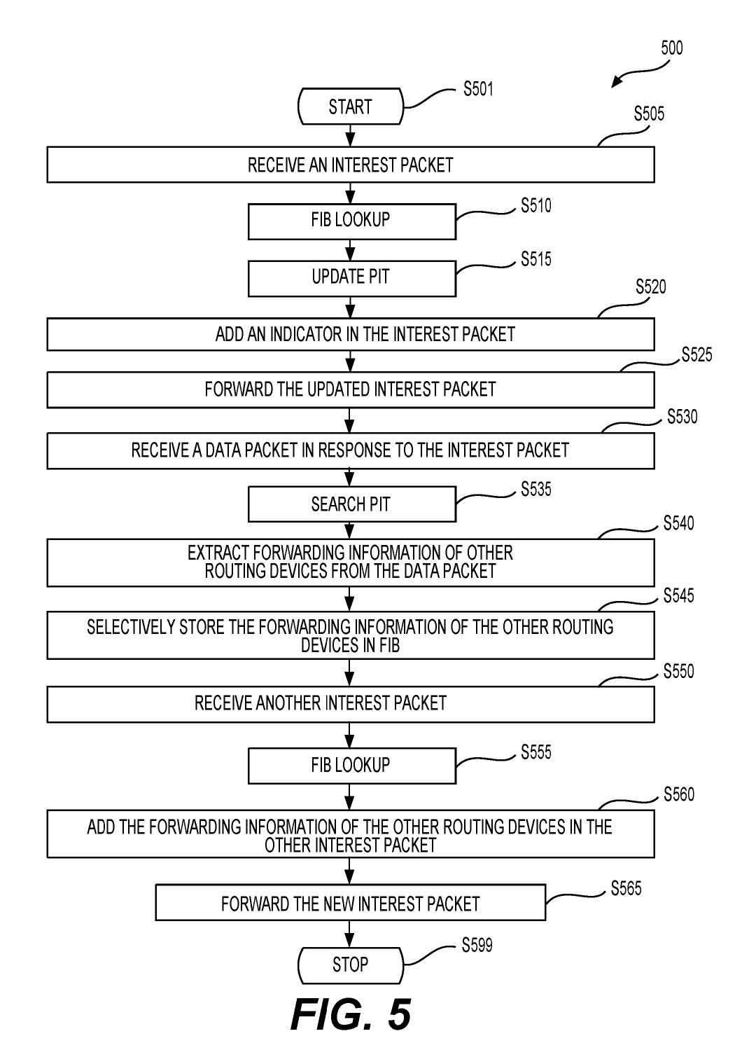

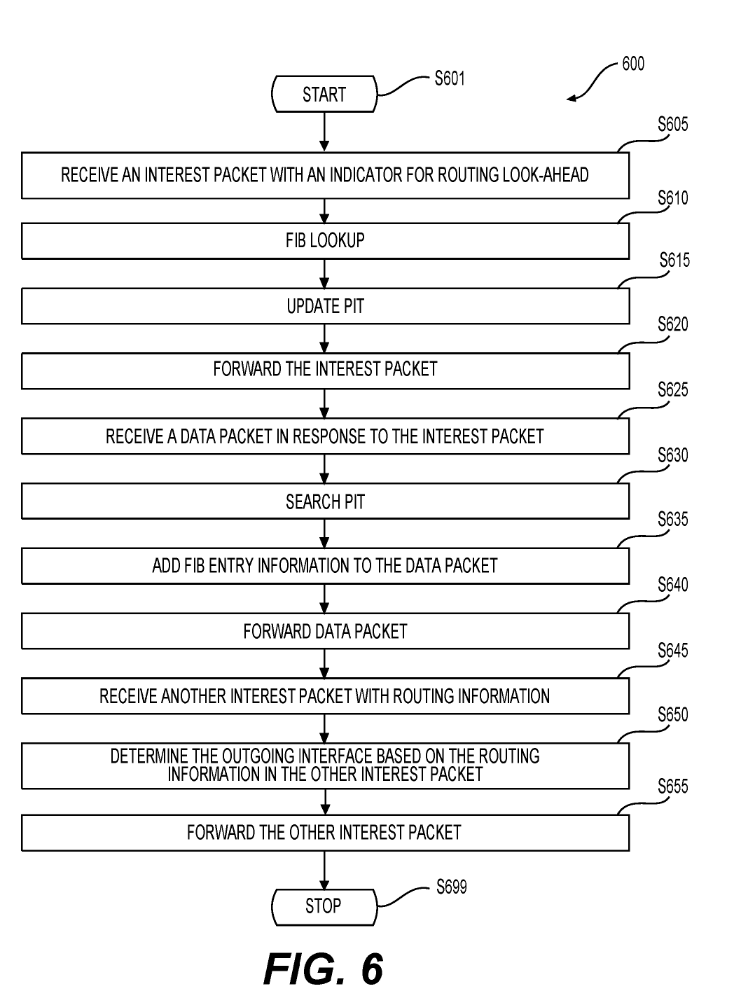

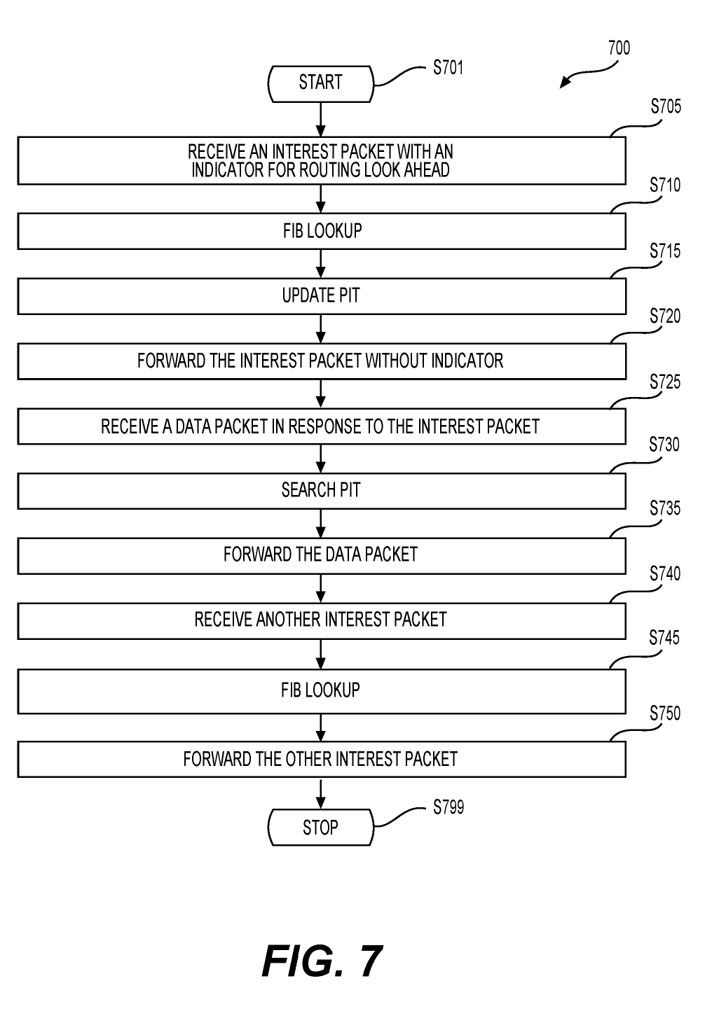

According to an aspect of the disclosure, the processing circuitry 420 is configured to process routing look-ahead. Specifically, the processing circuitry 420 includes a look-ahead routing module 421. In an example, the look-ahead routing module 421 is implemented using integrated circuits. In another example, the look-ahead routing module 421 is implemented as a processor executing software instructions. The functionality of the look-ahead routing module 421 will be described in detail with reference to FIG. 5, FIG. 6 and FIG. 7. For example, when the network device 410 is used in the network system 100 in the place of the network node N1, the initiating point for look-ahead processing, the look-ahead routing module 421 operates according to FIG. 5; when the network device 410 is used in the network system 100 in the place of the network node N3, an intermediate point for look-ahead processing, the look-ahead routing module 421 operates according to FIG. 6; and when the network device 410 is used in the network system 100 in the place of the network node N11, a terminating point for look-ahead processing, in the case of not utilizing/sharing interface metric set by the initiating point or determined locally for look-ahead processing, the look-ahead routing module 421 operates according to FIG. 7.

FIG. 5 shows a flow chart outlining a process 500 according to an embodiment of the disclosure. In an example, the process 500 is executed by the network device N1 in the FIG. 1 example. The process starts at S501 and proceeds to S505.

At S505, an interest packet having a specific name for a desired content object is received. In an example, the network device N1 receives the interest packet II0 via an incoming interface NO-N1 of the network node N1. The network device N1 parses the interest packet II0 and extracts the name “/d/e/f/g/h/i/l/”.

At S510, FIB lookup is performed. In an example, the network node N1 looks up the FIB, and determines an entry with a longest prefix match (LPM) to the name “/d/e/f/g/h/i/l/”. The entry for “/d/e/f/g/” in the FIB of the network node N1 has LPM to the name “/d/e/f/g/h/i/l/” and is referred to as entry N1-FIB-LPM-2. The entry N1-FIB-LPM-2 is indicative of an outgoing interface N1-N3 that is connected to the network node N3.

At S515, an entry in PIT is added or updated. For example, the network node N1 updates (or adds) an entry in a pending interest table (PIT) with matching name to the name “/d/e/f/g/h/i/l/” in the interest packet II0, and the entry is referred to as entry N1-PIT-2 as shown by 230 in FIG. 2. For example, the network node N1 marks the entry N1-PIT-2 for indicating a start point of the request of routing look-ahead.

At S520, an indicator for a request of routing look-ahead is added in the interest packet. In an example, the network node N1 includes an indicator for routing look-ahead in the interest packet II0 to generate an interest packet II1 as shown by 240.

At S525, the updated interest packet is forwarded. In an example, the network node N1 sends the interest packet II1 via the outgoing interface that is connected to the network node N3.

At S530, a data packet is received in response to the updated interest packet. In an example, the network node N1 receives the data packet DD3 in response to the interest packet II1.

At S535, the PIT is searched based on the name in the data packet. In an example, the network nodes N1 looks up the PIT to find the entry N1-PIT-2 with the matching name to the name “/d/e/f/g/h/i/l/” in the data packet DD3. The entry N1-PIT-2 is indicative of an incoming interface NO-N1 for the interest packet II0. The entry N1-PIT-2 is marked at S515 for the start point of the request of routing look-ahead.

At S540, forwarding information is extracted from data packet. In an example, the network node N1 extracts, from the data packet DD3, the FIB matching entry information of the network node N3 and the FIB matching entry information of the network node N6.

At S545, the forwarding information is selectively added in the FIB. In an example, the network node N1 selectively adds the FIB matching entry information in the entry N1-FIB-LPM-2 based on match length. For example, the match length of the network node N3 is shorter than the match length of the network node N1, thus the network node N1 adds the FIB matching entry information of the network node N3 in the entry N1-FIB-LPM-2. The match length of the network node N6 is longer than the match length of the network node N1, thus the network node N1 does not add the FIB matching entry information of the network node N6 in the entry N1-FIB-LPM-2.

At S550, another interest packet is received. In an example, when the network node N1 receives the interest packet III0 with the name “/d/e/f/g/h/i/m/”.

At S555, FIB lookup is performed. In an example, the network node N1 looks up the FIB, and determines that the entry N1-FIB-LPM-2 has LPM to the name “/d/e/f/g/h/i/m/”.

At S560, forwarding information of other routing devices is added in the interest packet. The network node N1 extracts from the entry N1-FIB-LPM-2 a first indicator that is indicative of the outgoing interface of the network node N1 (e.g., connected to the network node N3), and a second indicator that is indicative of the outgoing interface of the network node N3 (e.g., connected to the network node N6). In an example, the network node N1 updates the interest packet III0 to add the second indicator, and generates the interest packet III1.

At S565, the updated interest packet is forwarded. In an example, the network node N1 forwards the interest packet III1 via the outgoing interface that is indicated by the first indicator. Then the process proceeds to S599 and terminates.

FIG. 6 shows a flow chart outlining a process 600 according to an embodiment of the disclosure. In an example, the process 600 is executed by the network device N3 or N6 in the FIG. 1 example. The process starts at S601 and proceeds to S605.

At S605, an interest packet with an indicator for request of routing look-ahead is received. For example, the network node N3 receives the interest packet II1 via an incoming interface N1-N3 of the network node N3 and detects the indicator for routing look-ahead in the interest packet II1.

At S610, FIB lookup is performed. The network node N3 looks up the FIB, and determines an entry with an LPM to the name “/d/e/f/g/h/i/l/” in the interest packet II1. In the example, the entry for “/d/e/f/” in the FIB of the network node N3 has LPM to the name “/d/e/f/g/h/i/l/” and is referred to as entry N3-FIB-LPM-2 as shown by 360 in FIG. 3. The entry N3-FIB-LPM—-2 is indicative of an outgoing interface N3-N6 that is connected to the network node N6.

At S615, PIT is updated. In an example, the network node N3 updates (or adds) an entry in PIT with matching name to the name “/d/e/f/g/h/i/l/” in the interest packet II1, and the entry is referred to as entry N3-PIT-2 as shown by 250 in FIG. 2. For example, the network node N3 marks the entry N3-PIT-2 for recipient of the request of routing look-ahead, and includes FIB matching entry information of the entry N3-FIB-LPM-2, such as a match length, an identifier of the outgoing interface, and the like in the entry N3-PIT-2.

At S620, the interest packet is forwarded. The network node N3 forwards an interest packet I12, as shown by 260 in FIG. 2, (e.g., same as the interest packet II1) via the outgoing interface that is connected to the network node N6.

At S625, a data packet in response to the interest packet is received. In the example, the network node N3 receives the data packet DD2 in response to the interest packet II2.

At S630, PIT is searched to find an entry with matching name to the name in the data packet. The network nodes N3 looks up the PIT to find the entry N3-PIT-2 with the matching name to the name “/d/e/f/g/h/i/l/” in the data packet DD2. The entry N3-PIT-2 is indicative of an incoming interface N1-N3 for the interest packet I11 that is connected to, for example, the network node N1. In addition, the entry N3-PIT-2 is marked for the recipient of the request of routing look-ahead

At S635, forwarding information is added in the data packet. In an example, the entry N3-PIT-2 includes the FIB matching entry information of the entry N3-FIB-LPM-2, such as the match length, the identifier of the outgoing interface for the interest packet I12, and the like at the network node N3. The network node N3 adds the FIB matching entry information in the data packet DD2 to generate a data packet DD3 as shown by 370 in FIG. 3.

At S640, updated data packet is forwarded. For example, the network node N3 sends the data packet DD3 to the network node N1 via the interface N1-N3.

At S645, an interest packet with forwarding information is received. In an example, the network node N3 receives the interest packet III1 with an indicator for an outgoing interface at the network node N3.

At S650, outgoing interface is determined based on the forwarding information in the interest packet. In an example, the network node N3 extracts, from the interest packet III1, the indicator for outgoing interface at the network node N3, and determines the outgoing interface based on the indicator.

At S655, the interest packet is forwarded based on the forwarding information in the interest packet. Thus, in an example, the network node N3 can skip FIB lookup of the name “/d/e/f/g/h/i/m/”. Then the process proceeds to S699 and terminates.

FIG. 7 shows a flow chart outlining a process 700 according to an embodiment of the disclosure. In an example, the process 700 is executed by the network device N11 in the FIG. 1 example. The process starts at S701 and proceeds to S705.

At S705, an interest packet with an indicator for a request of routing look-ahead is received. In an example, the network node N11 receives the interest packet I13 via an incoming interface N6-N11 and detects the indicator for routing look-ahead in the interest packet II3.

At S710, FIB lookup is performed. In an example, the network node N11 looks up the FIB, and determines an entry with a LPM to the name “/d/e/f/g/h/i/l/” in the interest packet I13. The entry for “/d/e/f/g/h/i/” in the FIB of the network node N8 has LPM to the name “/d/e/f/g/h/i/l/” and is referred to as entry N11-FIB-LPM-2 as shown by 320 in FIG. 3. The entry N11-FIB-LPM-2 is indicative of an outgoing interface N11-N12 of the network node N11.

At S715, PIT is updated. In an example, the network node N11 updates/adds an entry in a pending interest table (PIT) with matching name to the name “/d/e/f/g/h/i/l/” in the interest packet I13, and the entry is referred to as entry N11-PIT-2 as shown by 290 in FIG. 2.

At S720, the request of routing look ahead is terminates. In an embodiment, the network node N11 is an edge router of a domain, such as a subscriber network domain, an Internet service provider network domain and the like, that forwards interest packets across domain border. When sharing in-domain information with outside routers is not allowed, the network node N11 terminates the request for routing look-ahead. In one example, the network node N11 does not mark the entry N11-PIT-2 for the request of routing look-ahead. The network node N11 removes the indicator for routing look-ahead from the interest packet I13 to generate an interest packet I14 as shown by 295 in FIG. 2, and forwards the interest packet I14 via the outgoing interface.

At S725, a data packet in response to the interest packet is received. For example, the network node N11 receives a data packet DD0, as shown by 310 in FIG. 3, in response to the interest packet I14. For example, the data packet DD0 includes the same name as the name “/d/e/f/g/h/i/l/” in the interest packets II0, II1, II2, II3 and II4.

At S730, PIT is searched. In an example, the network nodes N11 looks up the PIT to find the entry N11-PIT-2 with the matching name to the name “/d/e/f/g/h/i/l/” in the data packet DD0. The entry N11-PIT-2 is indicative of the incoming interface N6-N11 of the interest packet I13 that is connected to, for example, the network node N6.

At S735, data packet is forwarded. The network node N11 forwards a data packet DD1 as shown by 330 in FIG. 3, (e.g., same as the received data packet DD0) to the network node N6 via the interface N6-N11.

At S740, another interest packet with forwarding information is received. In an example, the network node N11 receives another interest packet with forwarding information.

At S745, FIB lookup is performed. In an example, the forwarding information does not include the forwarding information of the network node N11. Thus, the network node N11 performs regular FIB lookup to determine an outgoing interface for the other interest packet. In an example, the network node N11 removes the forwarding information from the other interest packet.

At S750, the interest packet (or the updated interest packet) is forwarded. Then, the process proceeds to S799 and terminates.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A network device for information centric networking (ICN), comprising:
interface circuitry configured to receive signals carrying incoming packets and transmit signals carrying outgoing packets via interfaces;
processing circuitry configured to:
receive a first interest packet carrying a first name for a content object to request;
add an indicator for routing look-ahead in the first interest packet to generate a first updated interest packet;
select a first entry in a forwarding information base (FIB) based on a lookup in the FIB for matching entries to the first name, the first entry being indicative of an outgoing interface;
forward the first updated interest packet via the outgoing interface that is indicated by the first entry;
receive a data packet in response to the first updated interest packet, the data packet carrying forwarding information of the first updated interest packet at devices that forward the first updated interest packet; and
store the forwarding information of the first updated interest packet at the devices in the first entry.

2. The network device of claim 1, wherein the processing circuitry is configured to select the first entry with a longest prefix match (LPM) to the first name.

3. The network device of claim 2, wherein the processing circuitry is configured to selectively store a portion of the forwarding information with equal or shorter prefix matches than the LPM in the first entry.

4. The network device of claim 3, wherein the processing circuitry is configured to store the portion of the forwarding information with equal or shorter prefix matches in a second entry with a shorter prefix match than the LPM.

5. The network device of claim 2, wherein the processing circuitry is configured to set an indicator bit for identifying a portion of the forwarding information with a longer prefix match than the LPM.

6. The network device of claim 2, wherein the processing circuitry is configured to select, among the devices, consecutive devices to the network device that forward the first updated interest packet, and store forwarding information of the selected consecutive devices.

7. The network device of claim 6, wherein the processing circuitry is configured to store the forwarding information of the selected consecutive devices in a form of a list of identifiers for outgoing interfaces respectively at the selected consecutive devices.

8. The network device of claim 1, wherein the processing circuitry is configured to
receive a second interest packet carrying a second name;
select the first entry based on a lookup of matching entries in the FIB to the second name;
add the forwarding information of the devices in the second interest packet to generate a second updated interest packet; and
forward the second updated interest packet via the outgoing interface that is indicated by the first entry.

9. A network device for information centric networking (ICN), comprising:
interface circuitry configured to receive signals carrying incoming packets and transmit signals carrying outgoing packets via interfaces;
processing circuitry configured to:
receive, via a first interface, a first interest packet carrying a first name for a content object to request;
detect an indicator for routing look-ahead in the first interest packet;
select a first entry in a forwarding information base (FIB) based on a lookup in the FIB for matching entries to the first name, the first entry being indicative of a second interface;
forward the first updated interest packet via the second interface that is indicated by the first entry;
receive a data packet in response to the first interest packet;
add forwarding information of the first entry in the data packet to generate an updated data packet; and
forward the updated data packet via the first interface.

10. The network device of claim 9, wherein the processing circuitry is configured to select the first entry with a longest prefix match (LPM) to the first name.

11. The network device of claim 9, wherein the processing circuitry is configured to
add the forwarding information of the first entry in a pending interest entry corresponding to the first name;
extract the forwarding information from the pending interest entry when the data packet corresponding to the first interest packet is received; and
add the extracted forwarding information in the data packet to generate the updated data packet.

12. The network device of claim 11, wherein the processing circuitry is configured to:
add a match length of the LPM and an identifier for the second interface in the pending interest entry corresponding to the first name.

13. The network device of claim 9, wherein the processing circuitry is configured to:
receive a second interest packet carrying forwarding information that is indicative of the second interface; and
forward the second interest packet via the second interface.

14. A method for information centric networking (ICN), comprising:
receiving, at a network device, a first interest packet carrying a first name for a content object to request;
adding an indicator for routing look-ahead in the first interest packet to generate a first updated interest packet;
selecting a first entry in a forwarding information base (FIB) based on a lookup in the FIB for matching entries to the first name, the first entry being indicative of an outgoing interface of the network device;
forwarding the first updated interest packet via the outgoing interface that is indicated by the first entry;
receiving a data packet in response to the first updated interest packet, the data packet carrying forwarding information of the first updated interest packet at devices that forward the first updated interest packet; and
storing the forwarding information in the first entry.

15. The method of claim 14, wherein selecting the first entry in the FIB based on the match of entries in the FIB to the first name further comprises:
selecting the first entry with a longest prefix match (LPM) to the first name.

16. The method of claim 15, wherein storing the forwarding information in the first entry further comprises:
selectively storing a portion of the forwarding information with equal or shorter prefix matches than the LPM in the first entry.

17. The method of claim 16, wherein further comprises:
storing the portion of the forwarding information with equal or shorter prefix matches in a second entry with a shorter prefix match than the LPM.

18. The method of claim 15, further comprising:
setting an indicator bit for identifying a portion of the forwarding information with a longer prefix match than the LPM.

19. The method of claim 15, wherein storing the forwarding information in the first entry further comprises:
selecting, among the devices, consecutive devices to the network device that forward the first updated interest packet; and
storing forwarding information of the selected consecutive devices in the first entry.

20. The method of claim 19, wherein storing the forwarding information of the selected consecutive devices in the first entry further comprises:
storing a list of identifiers for outgoing interfaces respectively at the selected consecutive devices, the outgoing interfaces being used respectively to forward the first updated interest packet at the selected consecutive devices.

21. The method of claim 14, further comprising:
receiving a second interest packet carrying a second name;
selecting the first entry based on a lookup of matching entries in the FIB to the second name;
adding the forwarding information of the devices in the second interest packet to generate a second updated interest packet; and
forwarding the second updated interest packet via the outgoing interface that is indicated by the first entry.
